(19) United States
(12) Patent Application Publication
(10) Pub. No.: US 2017/0098349 A1
(43) Pub. Date: Apr. 6, 2017

(54) COMPUTER IMPLEMENTED METHOD OF PLAYING MULTIPLAYER IN BETWEEN CARD GAME

(71) Applicant: YELLOW TURTLE GAMING SOLUTIONS PRIVATE LIMITED, HYDERABAD (IN)

(72) Inventor: RAJENDRA ROWTHU, HYDERABAD (IN)

(21) Appl. No.: 15/285,490

(22) Filed: Oct. 5, 2016

(30) Foreign Application Priority Data
Oct. 5, 2015 (IN) 5307/CHE/2015

(51) Int. Cl. G07F 17/32

(52) U.S. Cl. CPC G07F 17/3293; G07F 17/3288; G07F 17/3244; G07F 17/3262

(57) ABSTRACT

A card based gaming system is proposed where depositing module is enabled to receive and depositing cash in a virtual bank account at least two players among a plurality of the players. Thereafter, a first distributing module distributes at least two cards from a deck of cards, amongst each selected player and a second distributing module distributes at least one card from the remaining deck of the cards after distributing at least two cards by the first distributing module from the deck of cards to each of the selected player. Then a winning determination module determines a winner in response to analyzing whether the distributed one card to each player, from the remaining deck of cards after distributing at least two cards from the deck of cards by the first determination module, is within a range of two distributed cards given to each player.

### FIELD OF INVENTION

The present invention relates to a computationally implemented gaming method enabling a two-card casino-style game played with at least one standard deck of cards, between multiple players against each other.

### BACKGROUND OF THE INVENTION

Establishments such as clubs, casinos etc. continuously require to innovate and introduce a new game to keep entertaining its customers. Such games are generally required to enable player to play against a banker or a dealer provided by the casino, rather than against the other players. Alternatively, in a “card room” game each player may have the option to act as dealer, whilst the establishment runs the game on behalf of the banker and takes fee from the players.

Also the players typically enjoy games which are rapid and which offer players a plurality of choices. A plurality of choices increases the player interest in games. It would therefore be desirable to provide card games comprising a plurality of new wagering options. The most popular casino style game played is ‘in-between’ which is played against the dealer by each player. In other words, the base game or the standard variant is available yet limited to only single player and played against the house or the dealer. However, the present invention discloses a multiplayer in-between card game which is played against the players and not against the house or dealer.

Therefore, there remains a need to overcome above mentioned problems and our invention resolve these entire problems.

### SUMMARY OF THE INVENTION

The main objective of the present invention is to overcome the limitations of the prior arts by providing a computationally implemented gaming method enabling a two-card casino-style game played with at least one standard deck of cards, between multiple players against each other.

The primary objective of the computationally implemented gaming method is to develop a card game more simple than any other card game involving plurality of players and a game, which is easy to understand in aspects of its rules. The computationally implemented gaming method is played socially to have fun by providing niche features like gifting or transferring cash from the virtual bank account of one player into the virtual bank account of other player. Another objective of the computationally implemented gaming method is to engage all age groups who are looking forward to compete with other player across the globe on any social platform. Yet, another objective of the computationally implemented gaming method is to provide a platform to engage within known and unknown groups by calendar invitees and engage players with multiplatform for the computationally implemented gaming method to continue.

The given invention, the computationally implemented gaming method is played with an additional feature of blind option wherein the at least one selected player is enabled to play blind and have a chance to win double the winning amount for each time he/she plays blind. In this embodiment, the computationally implemented gaming method shuffles the cards and deals two cards to every selected player facing down. The at least one selected player has to place the bet on whether the third card he/she takes from the deck of the card available in the computationally implemented gaming method is between the two dealt cards without opening and seeing the two cards he/she is dealt with. If the third card is not in between his two cards, then he/she loses. If the third card is in between his two cards, then he/she wins and earns double the ante he added in the virtual bank account. The blind option for the computationally implemented gaming method is played with insurance, wherein while playing blind, the at least one player has the option to take insurance so that whenever he/she loses while playing blind, half of his/her losing amount is returned back. Here, the player before starting the game has to take insurance by paying a predetermined amount of cash in the virtual bank account of the computationally implemented gaming method so that if he/she loses a blind game as explained above, only half of the amount is held back and other half is given to the player. Also the computationally implemented gaming method, the selected player plays the computationally implemented gaming method with the standard deck of 54 cards including jokers card wherein, if at least one the selected player wins the computationally implemented gaming method then he/she gets two jokers as his/her first two dealt cards. In the event he/she gets one joker card and the other normal card, he/she uses the joker as either Ace or King so that the probability of winning the game is higher. Moreover, the computationally implemented gaming method, the game is played with open jokers, wherein the computationally implemented gaming method opens the joker at the start of the game. The open joker is any card drawn from the deck which acts as a joker for all games. So, if the at least one selected player gets the same number as open joker in one of the two cards, he/she use the open joker card as either Ace or King. In the event he/she gets both the cards dealt by the computationally implemented gaming method as open jokers, then he/she wins the computationally implemented gaming method. Further the computationally implemented gaming method, the computationally implemented gaming method is split into two games and played by the at least two selected players if the two cards received by them are in pairs. In this game, the at least two selected players have the option to bet twice each. Also, the at least two selected players have the option to push their second card game after all the players have completed their round in addition to the split option as mentioned above. Here, the at least two selected players have the option to split their game, if only two dealt cards are pairs and has the option to push their second card game after all the players finishes their round and then have a chance to bet and play with the second dealt card.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the flow chart of the given invention according to an embodiment of the invention; and

FIG. 2 shows the wire frame sequence of the computer implemented method of the invention.

### DETAIL DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

References to “one embodiment”, “at least one embodiment(s)”, “an embodiment”, “one example”, “an example”, “for example” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

The primary objective of the computer implemented gaming method is to develop a card game more simple than any other card game involving plurality of players and a game, which is easy to understand in aspects of its rules. The computationally implemented gaming method is played socially to have fun by providing niche features like gifting or transferring cash from the virtual bank account of one player into the virtual bank account of other player. Another objective of the computationally implemented gaming method is to engage all age groups who are looking forward to compete with other player across the globe on any social platform. Yet, another objective of the computationally implemented gaming method is to provide a platform to engage within known and unknown groups by calendar invitees and engage players with multiplatform for the computationally implemented gaming method to continue.

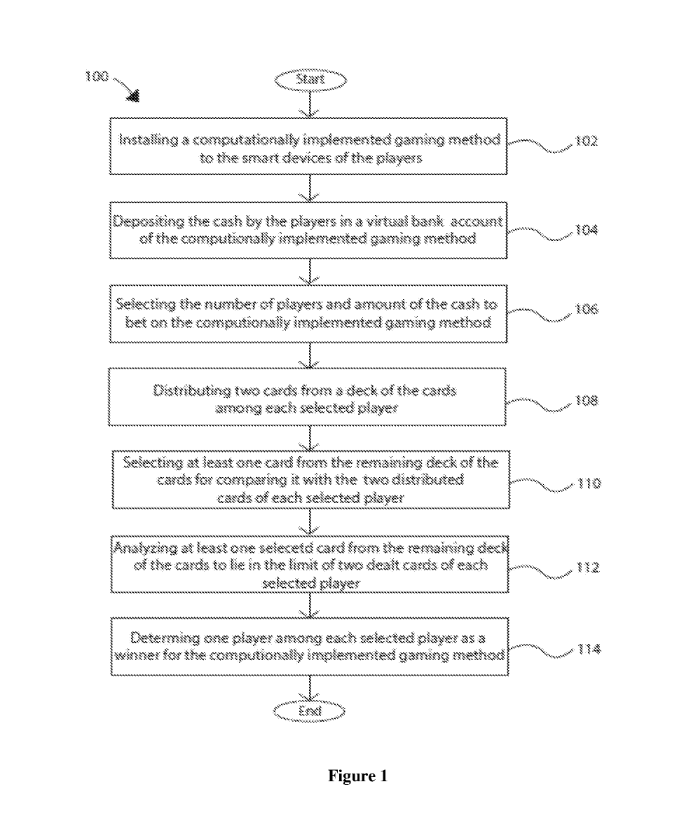

FIG. 1 illustrates the flow chart [100] of the given invention according to an embodiment of the invention which is also the preferred embodiment of the invention. Step 102 of FIG. 1 illustrates installing a computationally implemented gaming method to the smart devices of the players wherein, the installation takes place via various stores available, for example Google play store and iTunes also wherein, the smart device comprises a smart phone, laptop and/or computer or tablet and the scope of the smart device is not limited to only this. Further, the computationally implemented gaming method enables the player to create an account in the computationally implemented gaming method with at least two information such as player name, email id, date of birth and contact number. The player then login into the account by using the login credentials (username and password) wherein logging into the computationally implemented gaming method provides the player with different options on the computationally implemented gaming method. The computationally implemented gaming method herein provides various options to the user for restricting the computationally implemented gaming method via time, number of players, amount of the bet, language, display, game type, bet type or the combination thereof.

Step. 104 of FIG. 1 illustrate depositing cash in a virtual bank account exclusively designed for the computationally implemented gaming method via at least two players among a plurality of the players, wherein the process of deposition of the cash in the virtual bank account is been accomplished via depositing module. The process of deposition of the cash in the virtual bank account is done via each player willing to play the game, wherein the virtual bank account of the computationally implemented gaming method is linked with the at least one player bank account, exclusively opened in any commercial bank for the computationally implemented gaming method. Herein, once the at least one player has completed the process of depositing a cheque or a hard cash into his/her commercial bank account associated with the computationally implemented gaming method gets an update of the cash limit available in the virtual bank account associated with the computationally implemented gaming method on his/her smart device which further enables the at least one player to get started with the processes of the computationally implemented gaming method.

Step. 106 of FIG. 1 illustrate selecting the number of players and the amount of the cash to be bet on the computationally implemented gaming method by each selected player, wherein the process of selecting the number of players and the amount to be bet is done via selecting module. The selection for the at least two players willing to play is made by the process of the cash deposition in a virtual bank account by each individual player and therefore the computationally implemented gaming method send an updates and also shows the various options related to the computationally implemented gaming method to the at least two players willing to play the game. The selected player's further sets a limit for the cash to be bet on the computationally implemented gaming method according to his/her cash limit available in the virtual bank account.

Step. 108 of FIG. 1 illustrated distributing at least two cards from a deck of the cards, among each selected player. The game is played with a standard deck of 52 cards, excluding Joker and it is either two or three decks depending upon the number of players. The computationally implemented gaming method herein shuffles the cards and deals two cards to every selected player.

Step. 110 of FIG. 1 illustrates selecting at least one card from the remaining deck of the cards for comparing it with the at least two distributed cards of each selected players, wherein the above mentioned process is been accomplished with the help of the first module. Dealing of the cards starts from the first player in clockwise direction. First player firstly place the bet on whether the third card he/she takes from the computationally implemented gaming method is in between the two cards he/she is dealt with and further the process of placing the third card from the computationally implemented gaming method continues with each selected player.

Step. 112 of FIG. 1 illustrates analyzing the at least one selected card from the remaining deck of the cards to lie in the limit of at least two dealt cards of each selected players, wherein the above mentioned process is been accomplished by the second module. Step. 114 of FIG. 1 illustrates determining a winner in response to analyzing whether the distributed one card to each player, from the remaining deck of cards after distributing at least two cards from the deck of cards, is within a range of two distributed cards given to each player i.e. if the third card selected by the at least one player is not in between his two dealt cards, then he/she loses and if the third card is in between his two dealt cards, then he/she wins and earns double the ante he/she added in the virtual bank account of the computationally implemented gaming method and wherein, the above mentioned process is been accomplished by the winning determination module.

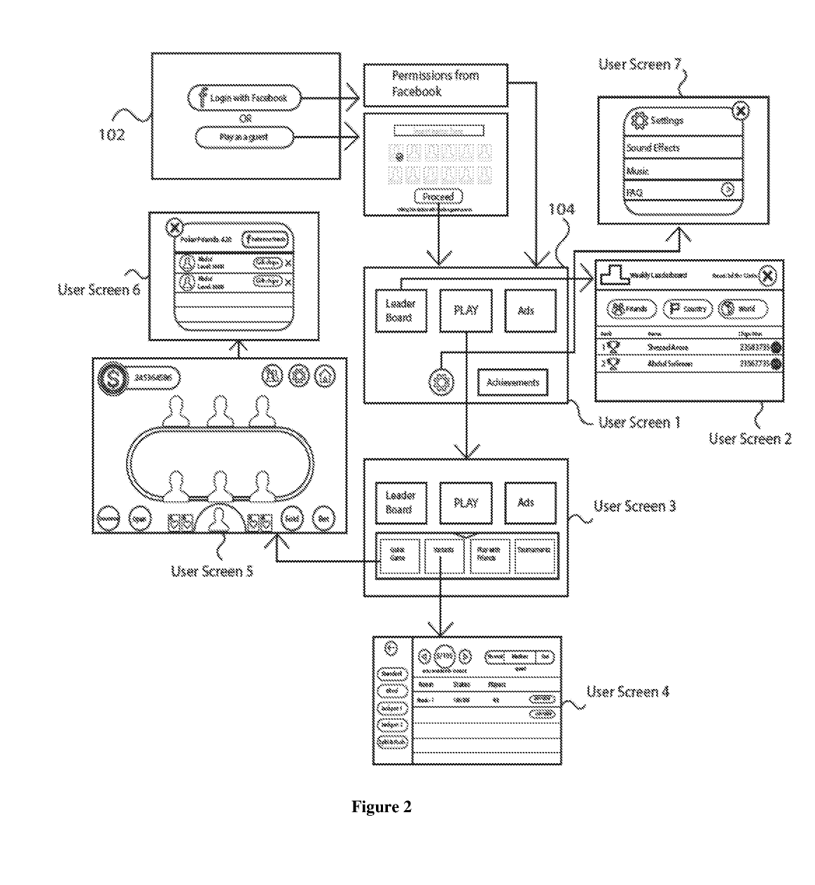

FIG. 2 illustrates the wire frame block diagram of the process in playing the game of the present invention. Step. 102 of FIG. 2 illustrate the process of logging into the computationally implemented gaming method, wherein the process of logging into the computationally implemented gaming method is accomplished via two processes, either via facebook or as a guest player. In the above mentioned process when the at least one player directly login the computationally implemented gaming method as a guest player, the at least one player has to give his/her identification proof to the computationally implemented gaming method, wherein the identification proof includes at least one of player name, email id, date of birth, contact number or the combination thereof. While, if the at least one player is logging into the computationally implemented gaming method via facebook then the computationally implemented gaming method directly fetch important, relevant and required identification data of the at least one player from the facebook profile available. The time when the at least one player has completed the process of logging into the computationally implemented gaming method then the at least one player is directed ahead for the further process.

Step. 104 of FIG. 2 illustrates a User Interface pop up screen 1 with at least three selectable options and with at least one icon, wherein the at least three selectable options present onto the user screen 1 of the computationally implemented gaming method is at least one of leader board, play, ads or the combination thereof and the at least one icon present onto the user screen 1 of the computationally implemented gaming method is a setting icon, achievement icon or the combination thereof. Once the at least one player select any one option among the at least three selectable options, for example the at least one player selects the option of a leader board then the at least one player is directed further to a user screen 2, wherein the user screen 2 comprises: various countries name, players name, rank of the at least one player who played previously and also the amount of cash earn by the same player in the virtual bank account. If the at least one player selects the play option from the user screen 2 of the computationally implemented gaming method then the at least one player is directed to user screen 3 comprising at least one option of quick game option, variant option, play with friends option, tournament option or the combination thereof. Among the available various options present onto the frequently opened user screen 3 the at least one player is directed to user screen 4 to select at least one option, wherein these option includes at least one of standard, blind, jackpot, split and push, room availability for the at least one player, virtual cash availability with the at least one player, number of players playing or the combination thereof. Also, if the at least one player choose the option of quick play present on the user screen 3 of the computationally implemented gaming method the at least one player is directly directed to a user screen 5 and is enabled to enter the option of betting present onto the user screen 5 of the computationally implemented gaming method. The at least one player is also enabled to enter the user screen 5 after going through with the user screen 3 of the computationally implemented gaming method. The user screen 5 is a graphically modified screen which is enable to give a real time feel of playing into a casino to the at least one player. Herein, the at least one player is enabled to see herself/himself onto the computationally implemented gaming method along with his/her name and the available virtual cash which he/she is assigned with. Herein the at least one player is also provided with at least one option of open playing, betting, insurance playing, fold playing or the combination thereof, wherein the at least one player is enabled to select any of the above mentioned playing mode for the computationally implemented gaming method. Also, the user screen 5 is provided with a setting option and the home page option, wherein if the at least one player if select the home page option then is directed to the user screen 2 directly and if the at least one player selects the setting option then he/she is directed to the user screen 6 which is indicative of the options such as who two players are playing, coins earned by them and is also provided with a option to gift there cash/coins to their friends or to any other player present in the game as a gift cash. The setting icon present onto the user screen 2 enables another user screen 7 which further comprises various setting options which is let available to the at least one player, wherein the various setting options includes the changing color, language, background, screen saver, background voice wherein the scope of the invention is not limited to only this.

In other embodiment of the given invention, the computationally implemented gaming method is played with an additional feature of blind option wherein the at least one selected player is enabled to play blind and have a chance to win double the winning amount for each time he/she plays blind. In this embodiment, the computationally implemented gaming method shuffles the cards and deals two cards to every selected player facing down. The at least one selected player has to place the bet on whether the third card he/she takes from the deck of the card available in the computationally implemented gaming method is between the two dealt cards without opening and seeing the two cards he/she is dealt with. If the third card is not in between his two cards, then he/she loses. If the third card is in between his two cards, then he/she wins and earns double the ante he added in the virtual bank account.

In another embodiment, the blind option for the computationally implemented gaming method is played with insurance, wherein while playing blind, the at least one player has the option to take insurance so that whenever he/she loses while playing blind, half of his/her losing amount is returned back. Here, the player before starting the game has to take insurance by paying a pre-determined amount of cash in the virtual bank account of the computationally implemented gaming method so that if he/she loses a blind game as explained above, only half of the amount is held back and other half is given to the player.

In yet first embodiment of the computationally implemented gaming method, the selected player plays the computationally implemented gaming method with the standard deck of 54 cards including jokers card wherein, if at least one the selected player wins the computationally implemented gaming method then he/she gets two jokers as his/her first two dealt cards. In the event he/she gets one joker card and the other normal card, he/she uses the joker as either Ace or King so that the probability of winning the game is higher.

In yet second embodiment of the computationally implemented gaming method, the game is played with open jokers, wherein the computationally implemented gaming method opens the joker at the start of the game. The open joker is any card drawn from the deck which acts as a joker for all games. So, if the at least one selected player gets the same number as open joker in one of the two cards, he/she use the open joker card as either Ace or King. In the event he/she gets both the cards dealt by the computationally implemented gaming method as open jokers, then he/she wins the computationally implemented gaming method.

In yet third embodiment of the computationally implemented gaming method, the computationally implemented gaming method is split into two games and played by the at least two selected players if the two cards received by them are in pairs. In this game, the at least two selected players have the option to bet twice each. Also, the at least two selected players have the option to push their second card game after all the players have completed their round in addition to the split option as mentioned above. Here, the at least two selected players have the option to split their game, if only two dealt cards are pairs and has the option to push their second card game after all the players finishes their round and then have a chance to bet and play with the second dealt card.

1. A computer implemented gaming method of playing multiplayer in-between card game comprising the step of:
a) depositing a cash in a virtual bank account of the computationally implemented gaming method via at least two players among a plurality of the players;
b) selecting at least two players who have deposited the cash in the virtual bank account and further setting a betting limit for each player amongst the selected players on the deposited cash;
c) distributing at least two cards from a deck of cards, among stench selected player;
d) distributing at least one card from the remaining deck of the cards after distributing at least two cards from the deck of cards to each of the selected player; and
e) determining a winner in response to analyzing whether the distributed one card to each player, from the remaining deck of cards after distributing at least two cards from the deck of cards, is within a range of two distributed cards given to each player.

2. The method as in claim 1 wherein it is played with an additional feature of blind option wherein the at least one player is enabled to play without seeing the cards dealt to them and have a chance to win double the winning amount for each time he/she plays blind.

3. The method as in claim 2 wherein it is played with insurance, wherein the at least one player has the option to take insurance so that whenever he/she loses while playing blind, half of his/her losing amount is returned back.

4. The method as in claim 1 wherein the player wins jackpot if his dealt cards are original joker cards.

5. The method as in claim 4 wherein it is played with open jokers, wherein the method opens the joker at the start of a game.

6. The method as in claim 1 wherein the at least two player have the option to split their game, if only two dealt cards are pairs and have the option to push their second card game after all the players finish their round and then have a chance to bet and play with the second dealt card.

7. The method as in claim 1 wherein the selection process of at least one card from the remaining deck of the cards in order to compare it with the at least two distributed cards of each selected players is random in nature.

8. The method as in claim 1 wherein a commercial bank is linked with the virtual bank account of the at least one player, wherein the at least one player deposit their cash in order to get connected through in the computer implemented gaming method platform.

9. A card based gaming system comprises of:
a) depositing module wherein the depositing module is enabled to receive and depositing cash in a virtual bank account of the computationally implemented gaming method via at least two players among a plurality of the players;
b) selecting module wherein the selecting module is enabled to select at least two players who have deposited the cash in the virtual bank account and is further enabled to set a betting limit for each player amongst the selected players on the deposited cash;
c) first module, wherein the first distributing module is enabled to distribute at least two cards from a deck of cards, amongst each selected player;
d) second module wherein the second distributing module is enabled to distribute at least one card from the remaining deck of the cards after distributing at least two cards by the first distributing module from the deck of cards to each of the selected player; and
e) winning determination module wherein the winning determination module is enabled to determine a winner in response to analyzing whether the distributed one card to each player, from the remaining deck of cards after distributing at least two cards from the deck of cards by the first determination module, is within a range of two distributed cards given to each player.

10. The gaming system as in claim 9 wherein the gaming system is enabled to be played with an additional feature of blind option wherein the at least one player is enabled to play without seeing the cards dealt to them and have a chance to win double the winning amount for each time he/she plays blind.

11. The gaming system as in claim 10 wherein the game can be played with an insurance, wherein while playing blind, the at least one player has the option to take insurance so that whenever he/she loses while playing blind, half of his/her losing amount is returned back.

12. The gaming system as in claim 9 wherein the player wins jackpot if his dealt cards are original joker cards.

13. The gaming system as in claim 12 wherein the game is enabled to be played with open jokers, wherein the computationally implemented gaming method opens the joker at the start of a game.

14. The gaming system as in claim 9 wherein the at least two player have the option to split their game, if only two dealt cards are pairs and have the option to push their second card game after all the players finish their round and then have a chance to bet and play with the second dealt card.

15. The gaming system as in claim 9 wherein the selection process of at least one card from the remaining deck of the cards in order to compare it with the at least two distributed cards of each selected players is random in nature.

16. The gaming system as in claim 9 wherein a commercial bank is linked with the virtual bank account of the at least one player, wherein the at least one player deposit their cash in order to get connected through in the computationally implemented gaming method platform.
